(19) United States
(12) Patent Application Publication
(10) Pub. No.: US 2017/0023827 A1
(43) Pub. Date: Jan. 26, 2017

(54) REFLECTIVE ELEMENT, BACKLIGHT MODULE AND DISPLAY DEVICE HAVING THE SAME

(71) Applicants: RADIANT OPTO-ELECTRONICS (SUZHOU) CO. LTD., Wujiang City (CN); RADIANT OPTO-ELECTRONICS CORPORATION, Kaohsiung City (TW)

(72) Inventors: Chung-Yung TAI, Kaohsiung City (TW); Wei-Hsuan CHEN, Kaohsiung City (TW); Fong-Ming LIU, Kaohsiung City (TW)

(21) Appl. No.: 15/288,856

(22) Filed: Oct. 7, 2016

Related U.S. Application Data
(63) Continuation of application No. PCT/CN2015/099113, filed on Dec. 28, 2015.

(30) Foreign Application Priority Data
May 21, 2015 (CN) 201510264072.1

(51) Int. Cl. G02F 1/1335

(52) U.S. Cl. CPC G02F 1/133605; G02F 1/133603; G02F 1/133606; G02F 2001/133607

(57) ABSTRACT

A reflective element is adapted for use in a backlight module, which includes a plurality of optical lens elements each being provided with a light emitting element. The reflective element includes a plurality of interconnecting reflective portions, each defining a through hole that is adapted for accommodating a corresponding one of the optical lens elements and a corresponding one of the light emitting elements, and being adapted for reflecting light incident from the corresponding one of the light emitting elements. A backlight module and a display device including the reflective element are also disclosed.

### CROSS-REFERENCE TO RELATED APPLICATION

This application is a bypass continuation of International Application No. PCT/CN2015/099113 filed on Dec. 28, 2015, which claims priority of Chinese Patent Application Serial No. 201510264072.1, filed on May 21, 2015, the entire content of each of which is incorporated herein by reference.

### FIELD

The disclosure relates to a reflective element adapted for use in a backlight module, more particularly to a reflective element including a plurality of interconnecting reflective portions. The disclosure also relates to a backlight module and a display device including the reflective element.

### BACKGROUND

A conventional direct type light-emitting diode (LED) backlight module as shown in FIG. 1 includes a plurality of lens elements 11, a reflecting sheet 12, a diffusive plate 13, and a liquid crystal panel 14.

The lens elements 11, each receiving an LED therein, are arranged in an array on the reflecting sheet 12. The diffusive plate 13 is disposed to be spaced apart from and parallel to the reflecting sheet 12. The lens elements 11 are installed to face toward the diffusive plate 13. The liquid crystal panel 14 is disposed to be spaced apart from and parallel to the diffusive plate 13. The diffusive plate 13 is interposed between the reflecting sheet 12 and liquid crystal panel 14. Such configuration provides a relatively high dynamic contrast ratio

When the LEDs of the conventional direct type LED backlight module emit light, a part of the light is transmitted directly through top surfaces of the lens elements 11 as illustrated in FIG. 1. Another part of the light is transmitted through lateral sides of the lens elements 11 and may be reflected toward the diffusive plate 13 by the reflecting sheet 12, so as to prevent formation of dark areas on the diffusive plate 13 at positions corresponding to positions that are in between adjacent ones of the lens elements 11.

However, since the light transmitted through the lateral sides of the lens elements 11 is reflected by the reflecting sheet 12 at a relatively large incident angle, the reflecting sheet 12 may be incapable of reflecting and directing the light in a desirable way to prevent formation of the dark areas, and thus fails to provide a uniform luminous distribution.

Therefore, there is a need for improvement on the reflective sheet 12 to prevent formation of the dark areas on the diffusive plate 13.

### SUMMARY

Therefore, an object of the disclosure is to provide a reflective element that can alleviate the drawback of the prior art.

Another object of the disclosure is to provide a backlight module including the reflective element that can alleviate the drawback of the prior art

According to one aspect of the disclosure, there is provided a reflective element adapted for use in a backlight module, which includes a plurality of optical lens elements each being provided with a light emitting element. The reflective element includes a plurality of interconnecting reflective portions, each defining a through hole that is adapted for accommodating a corresponding one of the optical lens elements and a corresponding one of the light emitting elements, and being adapted for reflecting light incident from the corresponding one of the light emitting elements

According to another aspect of the disclosure, there is provided a backlight module. The backlight module includes a substrate, a plurality of light-emitting elements, a plurality of optical lens elements, a reflective element, and an optical plate. The light emitting elements are mutually spaced-apart and are disposed on the substrate. The optical lens elements are mutually spaced-apart and are correspondingly disposed on the light emitting elements. The reflective element includes a plurality of interconnecting reflective portions each defining a through hole for accommodating a corresponding one of the light emitting elements and a corresponding one of the optical lens elements, and for reflecting light incident from the corresponding one of the light emitting elements. Each of the reflective portions has a height not greater than that of the corresponding one of the optical lens elements. The optical plate is disposed on the reflective element opposite to the substrate and has a light incident surface facing the reflective element.

### BRIEF DESCRIPTION OF THE DRAWINGS

Other features and advantages of the disclosure will become apparent in the following detailed description of the embodiments with reference to the accompanying drawings, of which:

FIG. 1 is a schematic view of a conventional direct type LED backlight module;

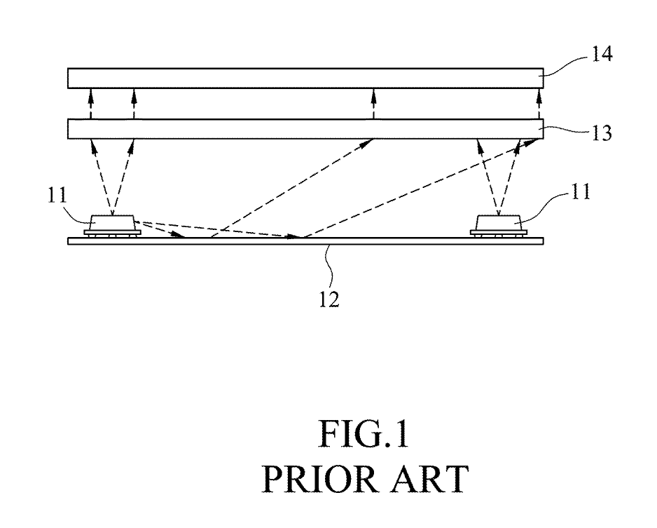

FIG. 2 is a fragmentary exploded perspective view illustrating an exemplary embodiment of a display device according to the disclosure;

FIG. 3 is a side view of the exemplary embodiment illustrating a backlight module of the display device;

FIG. 4 is a fragmentary top view of the exemplary embodiment, illustrating a reflective element of the display device; and

FIG. 5 is a fragmentary perspective view of the exemplary embodiment, illustrating a modified reflective element.

### DETAILED DESCRIPTION

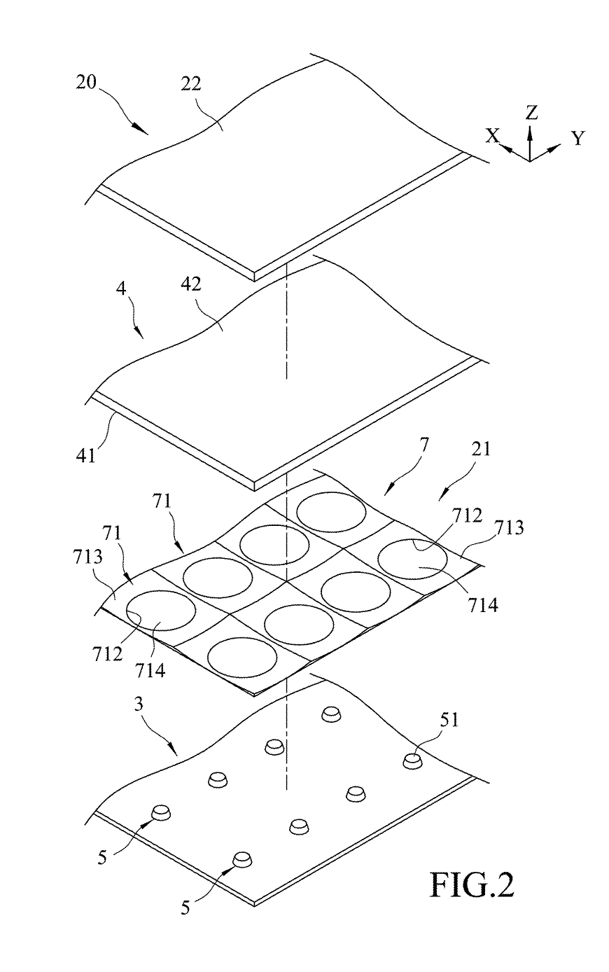

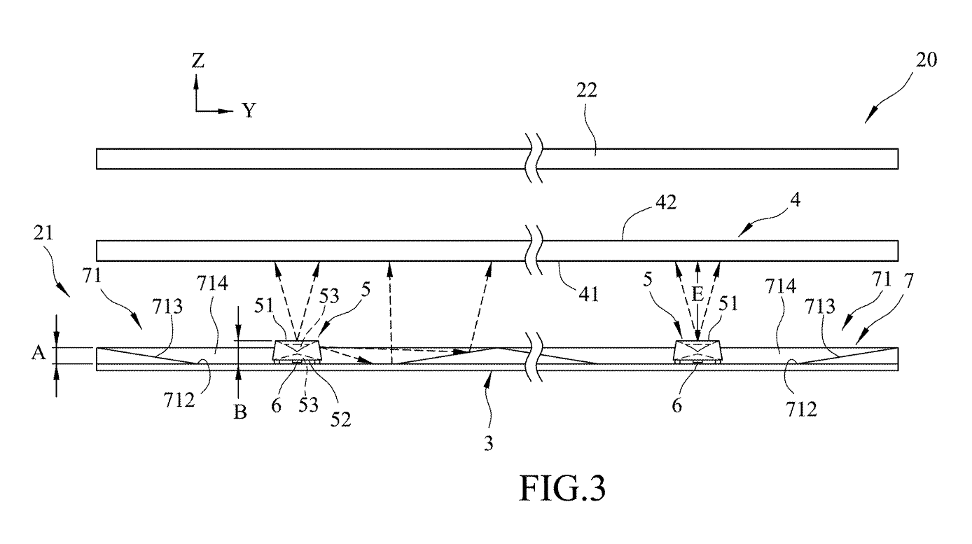

FIGS. 2 and 3 illustrate the exemplary embodiment of a display device 20 according to the present disclosure. The display device 20 includes a backlight module 21 and a liquid crystal panel 22. The backlight module 21 includes a substrate 3, a plurality of mutually spaced-apart light emitting elements 6 disposed on the substrate 3, a plurality of mutually spaced-apart optical lens elements 5 correspondingly disposed on the light emitting elements 6, a reflective element 7, and an optical plate 4.

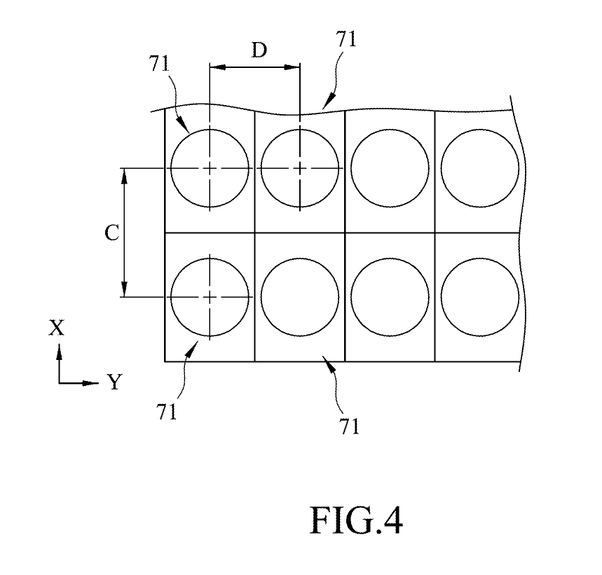

The reflective element 7 includes a plurality of interconnecting reflective portions 71 as illustrated in FIG. 2, each defining a through hole 714 for accommodating a corresponding one of the light emitting elements 6 and a corresponding one of the optical lens elements 5, and for reflecting light incident from the corresponding one of the light emitting elements 6. Each of the reflective portions 71 has a height (A) not greater than a height (B) of the corresponding one of the optical lens elements 5 (see FIG. 3), and has a reflective surrounding surface 713 that defines the through hole 714. In certain embodiments, the through hole 714 of each of the reflective portions 71 is tapered toward the substrate 3 (see FIG. 3), and has a circular opening 712 that opens toward the substrate 3 (see FIG. 2). In certain embodiments, the reflective portions 71 of the reflective element 7 are arranged in a coplanar manner as illustrated in FIG. 4.

The optical plate 4 is disposed on the reflective element 7 opposite to the substrate 3, and has a light incident surface 41 facing the reflective element 7, and a light exit surface 42 opposite to the light incident surface 41. In certain embodiments, the optical plate 4 is a diffusive plate.

In certain embodiments, each of the optical lens elements 5 has top and bottom surfaces 51, 52 each being formed with a recess 53. The recess 53 of the bottom surface 52 of each of the optical lens elements 5 is configured to increase the light-emitting angle of the corresponding one of the light emitting elements 6, and the recess 53 of the top surface 51 of each of the optical lens elements 5 may reflect a part of the light emitted from the light emitting elements 6 toward a direction that is parallel to the substrate 3, while another part of the light is transmitted directly toward the optical plate 4. The recess 53 of the top surface 51 of each of the optical lens elements 5 may be formed by indenting downwardly and inwardly from an outer perimeter of the top surface 51 toward the bottom surface 52 as illustrated in FIG. 3. In certain embodiments, in order to prevent the light to be transmitted directly toward the optical plate 4 and to diffuse the light effectively, the optical lens elements 5 may be configured as reflective secondary optical lenses.

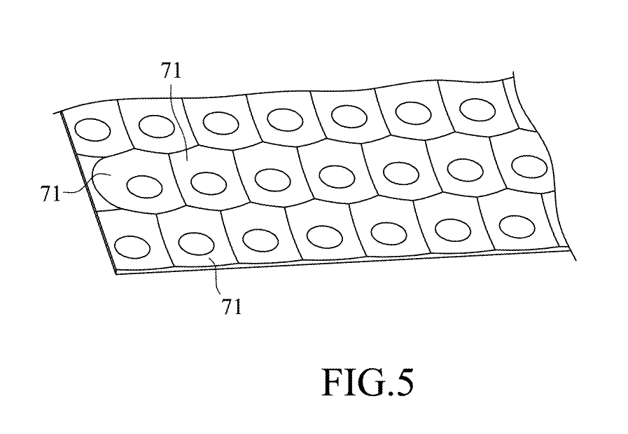

In certain embodiments, the reflective portions 71 of the reflective element 7 are arranged in a two dimensional array as illustrated in FIG. 4, having a plurality of rows in a first direction (X). One of the reflective portions 71 in one of the rows is aligned with a corresponding one of the reflective portions 71 in an adjacent one of the rows in a second direction (Y) perpendicular to the first direction (X). In such embodiments, a center-to-center distance (C) between adjacent two of the reflective portions 71 along the first direction (X) may be greater than a center-to-center distance (D) between adjacent two of the reflective portions 71 along the second direction (Y) as shown in FIG. 4. It should be noted that, under the premise that uniformity of the luminous distribution of the backlight module 21 is not adversely affected, the center-to-center distance (C) between adjacent two of the reflective portions 71 along the first direction (X) may be adjusted according to demand. It may be noted that, in certain embodiments, the reflective portions 71 of the reflective element 7 are arranged in staggering rows as illustrated in FIG. 5.

In certain embodiments, a distance (E) between the light incident surface 41 of the optical plate 4 and the optical lens elements 5 along a third direction (Z), which is perpendicular to the first and second directions (X, Y), is in a negative correlation to a surface density of the light emitting elements 6 on the substrate 3. A thickness of the backlight module 21 is positively correlated to the distance (E). That is, when the distance (E) of the light emitting elements 6 increases with an increase in the thickness of the backlight module 21, the light emitted from the light emitting elements 6 may have a relatively large incident angle at the light incident surface 41 of the optical plate 4. By such, the surface density of the light emitting elements 6 can be reduced. Conversely, when the distance (E) decreases with a decrease in the thickness of the backlight module 21, the surface density of the light emitting elements 6 must be increased due to the limited incident angle on the light incident surface 41 of the optical plate 4.

Referring back to FIGS. 2 and 3, when the light emitting elements 6 of the backlight module emit light, a part of the light is transmitted directly through the recess 53 of the top surface 51 of the corresponding one of the optical lens elements 5 along the third direction (Z) toward the light incident surface 41 of the optical plate 4, and is projected out from the light exit surface 42. Another part of the light is transmitted through the sides of the corresponding one of the optical lens elements 5, is reflected by the reflective surrounding surface 713 of a corresponding one of the reflective portions 71 toward the light incident surface 41, and is projected out from the light exit surface 42.

With the arrangement of the optical lens elements 5 and the reflective portions 71 of the reflective element 7, formation of dark areas on the optical plate 4 at positions corresponding to positions that are in between adjacent ones of the optical lens elements 5 is effectively prevented as compared to the above-mentioned conventional LED backlight module, thereby improving the uniformity of the luminous distribution of the backlight module. Furthermore, the improved luminous distribution allows for a reduction of the total number of the light emitting elements 6 used or a decrease in the surface density of the light emitting elements 6, or allows for a reduction of the distance (E) between the light emitting elements 6 and the optical plate 4 so that the thickness of the display device 20 can be reduced.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A reflective element adapted for use in a backlight module, which includes a plurality of optical lens elements each being provided with a light emitting element, said reflective element comprising:
a plurality of interconnecting reflective portions, each defining a through hole that is adapted for accommodating a corresponding one of the optical lens elements and a corresponding one of the light emitting elements, and being adapted for reflecting light incident from the corresponding one of the light emitting elements.

2. The reflective element of claim 1, wherein:
said reflective element is adapted to be disposed on a substrate on which the light emitting elements are provided; and
each of said reflective portions has a reflective surrounding surface that defines said through hole which is tapered toward the substrate.

3. The reflective element of claim 2, wherein each of said through holes has a circular opening that opens toward the substrate.

4. The reflective element of claim 1, wherein said reflective portions are integrally formed.

5. The reflective element of claim 1, wherein said reflective portions are arranged into a two dimensional array having a plurality of rows in a first direction, one of said reflective portions in one of the rows is aligned with a corresponding one of said reflective portions in an adjacent one of the rows in a second direction perpendicular to the first direction.

6. The reflective element of claim 5, wherein a center-to-center distance between adjacent two of said reflective portions along said first direction is greater than a center-to-center distance between adjacent two of said reflective portions along said second direction.

7. The reflective element of claim 1, wherein said reflective portions of said reflective element are arranged in staggering rows.

8. The reflective element of claim 1, wherein said reflective portions are arranged in a coplanar manner.

9. A backlight module, comprising:
a substrate;
a plurality of mutually spaced-apart light emitting elements disposed on said substrate;
a plurality of mutually spaced-apart optical lens elements correspondingly disposed on said light emitting elements;
a reflective element including a plurality of interconnecting reflective portions each defining a through hole for accommodating a corresponding one of said light emitting elements and a corresponding one of said optical lens elements and for reflecting light incident from the corresponding one of said light emitting elements, each of said reflective portions having a height not greater than that of the corresponding one of said optical lens elements; and
an optical plate disposed on said reflective element opposite to said substrate and having a light incident surface facing said reflective element.

10. The backlight module of claim 9, wherein each of said reflective portions has a reflective surrounding surface defining said through hole which is tapered toward the substrate.

11. The backlight module of claim 9, wherein:
said reflective portions are arranged into a two dimensional array having a plurality of rows in a first direction, one of said reflective portions in one of the rows is aligned with a corresponding one of said reflective portions in an adjacent one of the rows in a second direction perpendicular to the first direction; and
a center-to-center distance between adjacent two of said reflective portions along said first direction is greater than a center-to-center distance between adjacent two of said reflective portions along said second direction.

12. The backlight module of claim 9, wherein said reflective portions are arranged into staggering rows.

13. The backlight module of claim 9, wherein each of said optical lens elements has top and bottom surfaces each being formed with a recess.

14. The backlight module of claim 13, wherein, for each of said optical elements, said recess of said top surfaces extends downwardly and inwardly from an outer perimeter of said top surface toward said bottom surface.

15. The backlight module of claim 9, wherein a distance between said light incident surface of said optical plate and said optical lens elements is in negative correlation to a surface density of said light emitting elements on said substrate.

16. The backlight module of claim 9, wherein said reflective portions of said reflective elements are arranged in a coplanar manner.

17. A display device, comprising:
said backlight module of claim 9; and
a liquid crystal panel disposed on said optical plate.
